(19) United States
(12) Patent Application Publication
(10) Pub. No.: US 2019/0101612 A1
(43) Pub. Date: Apr. 4, 2019

(54) ELECTRONIC DEVICE WITH DISTANCE DETECTION FUNCTION AND DISTANCE DETECTION METHOD THEREOF

(71) Applicant: INVENTEC APPLIANCES CORP., New Taipei City (TW)

(72) Inventor: Chih-Hsuan Hsiao, New Taipei City (TW)

(21) Appl. No.: 15/822,369

(22) Filed: Nov. 27, 2017

(30) Foreign Application Priority Data
Sep. 30, 2017 (CN) 201710961197.9

(51) Int. Cl. G01S 3/808

(52) U.S. Cl. CPC G01S 3/808

(57) ABSTRACT

An electronic device with a distance detection function including a master device and a slave device is provided. The master device includes a first transceiver and an ultrasonic receiver. The slave device includes a second transceiver and an ultrasonic transmitter. The first transceiver and the second transceiver perform two-way communication and pairing with a radio frequency. The ultrasonic receiver receives an ultrasonic wave from the ultrasonic transmitter so that the master device calculates a relative distance to the slave device according to the flight time of the ultrasonic wave.

This application claims the benefit of People's Republic of China application Serial No. 201710961197.9, filed Sep. 30, 2017, the subject matter of which is incorporated herein by reference.

### BACKGROUND OF THE INVENTION

### Field of the Invention

The invention relates in general to an electronic device, and more particularly to an electronic device with a distance detection function and a distance detection method using the same.

### Description of the Related Art

Along with the advance in technology, it is very common that people may get lost of their portable electronic devices and cannot find them, and this is indeed a big nuisance to the owners. Besides, when dementia people, kids or pets are lost, their family members will suffer from tremendous nervousness and uneasiness. Therefore, anti-loss portable electronic devices are provided in response to people's needs. Although portable electronic devices may provide a warning effect, the owners of portable electronic devices can only roughly know a range within which the object of detection is located, but still cannot precisely obtain an actual distance to the object. Besides, the conventional technology performs a distance detection using the attenuation of a radio frequency power, which is often affected by an antenna radiation pattern and ends up with inferior accuracy of the distance detection. Therefore, how to resolve the problems encountered in the conventional technology and provide a more reliable anti-loss device has become a prominent task for the industries.

### SUMMARY OF THE INVENTION

The invention is directed to an electronic device with a distance detection function and a distance detection method using the same for calculating a relative distance according to a flight time of an ultrasonic wave to increase the accuracy of distance detection.

According to one embodiment of the invention, an electronic device with a distance detection function including a master device and a slave device. The master device includes a first transceiver and an ultrasonic receiver. The slave device includes a second transceiver and an ultrasonic transmitter. The first transceiver and the second transceiver perform two-way communication and pairing with a radio frequency. The ultrasonic receiver receives an ultrasonic wave from the ultrasonic transmitter so that the master device calculates a relative distance to the slave device according to a flight time of the ultrasonic wave.

According to another embodiment of the invention, a distance detection method used in an electronic device is provided. The electronic device includes a master device and a slave device. The distance detection method includes the following steps. The master device and the slave device perform two-way communication and pairing with a radio frequency. A triggering condition for distance detection is set. When the triggering condition is satisfied, the master device receives an ultrasonic wave from the slave device and calculates a relative distance to the slave device according to a flight time of the ultrasonic wave.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of an electronic device with a distance detection function according to an embodiment of the invention.

FIG. 2 is a flowchart of a distance detection method according to an embodiment of the invention.

FIG. 3 is a schematic diagram of an electronic device with a distance detection function according to another embodiment of the invention.

FIG. 4 is a schematic diagram of a time axis of the operation process of the electronic device with a distance detection function of FIG. 3.

### DETAILED DESCRIPTION OF THE INVENTION

Detailed descriptions of the invention are disclosed below with a number of embodiments. However, the disclosed embodiments are for explanatory and exemplary purposes only, not for limiting the scope of protection of the invention. Similar/identical designations are used to indicate similar/identical elements.

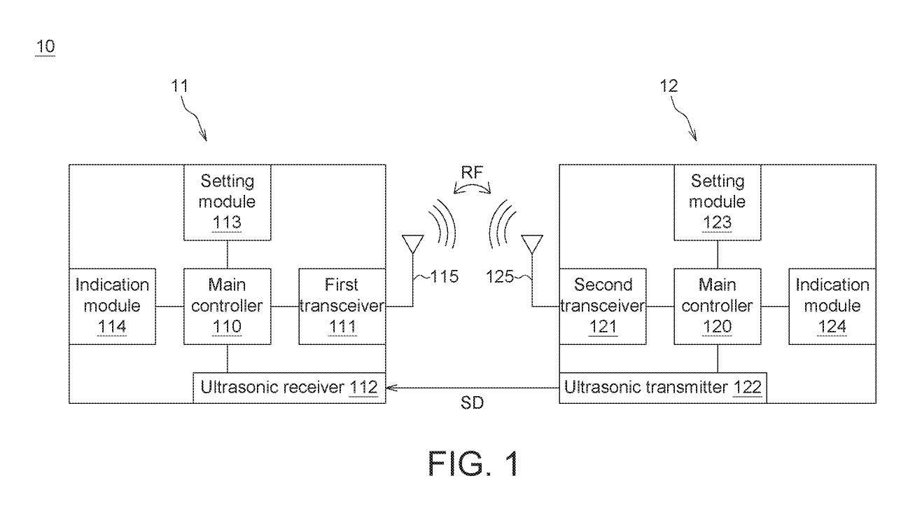

Referring to FIG. 1, a schematic diagram of an electronic device with a distance detection function 10 according to an embodiment of the invention is shown. The electronic device with a distance detection function 10 includes a master device 11 and a slave device 12. The master device 11 and the slave device 12 respectively have a main controller 110 and a main controller 120, such as microprocessors, for performing the logic operation and setting the firmware. The master device 11 may include a first transceiver 111, an ultrasonic receiver 112, a setting module 113 and an indication module 114 each being electrically connected to the main controller 110. The slave device 12 may include a second transceiver 121, an ultrasonic transmitter 122, a setting module 123 and an indication module 124 each being electrically connected to the main controller 120.

In the present embodiment, the master device 11 and the slave device 12, can be a mobile phone and a peripheral device or an anti-loss device, communicate to each other with radio frequency using Bluetooth, WiFi, or Zigbee wireless communication technology, for example. Once the master device 11 and the slave device 12 are paired, the master device 11 and the slave device 12 will be able to communicate to each other.

The first transceiver 111 and the second transceiver 121 respectively have an antenna module 115 and an antenna module 125 for transmitting and receiving a radio frequency signal RF. The first transceiver 111 and the second transceiver 121 respectively encode and decode the radio frequency signal RF, so that the master device 11 and the slave device 12 perform two-way communication and pairing. Furthermore, the master device 11 or the slave device 12 may initiate a request for distance detection according to a specific triggering condition. In the present embodiment, the quantity of slave device 12 is not limited to one. If the quantity of slave device 12 is more than one, each slave device needs to be paired first to confirm its identity. For example, before distance detection is performed, the first transceiver 111 emits a radio frequency inquiry code to the second transceiver 121, and the slave device 12, having confirmed the radio frequency inquiry code, will inform the master device 11 to complete pairing. Then, the ultrasonic transmitter 122 may output an ultrasonic wave reply code to the ultrasonic receiver 112 for the master device 11 to perform distance detection, and the radio frequency inquiry code includes the identity code of the paired slave device 12 and avoid other slave device 12 making a mistake to reply. Thus, interference of other slave device 112 can be reduced and power consumption can be saved.

The ultrasonic receiver 112 may include a microphone, and the ultrasonic transmitter 122 may include an audio source amplifier. The ultrasonic receiver 112 is used for receiving an ultrasonic wave SD from the ultrasonic transmitter 122 for the master device 11 to calculate a flight time of the ultrasonic wave SD, and the ultrasonic wave SD has a transmission speed of 34.3 cm per millisecond, for example. When the master device 11 and the slave device 12 are separated by 5 meters (m), the flight time of the ultrasonic wave SD is about 14.6 milliseconds (ms).

In the present embodiment, the transmission speed of the radio frequency signal RF is far faster than the transmission speed of the ultrasonic wave SD. Therefore, the master device 11 may estimate the emission time and the arrival time of the ultrasonic wave SD according to an initiation time of the first transceiver 111 at which the first transceiver 111 initiates an instruction of distance detection and a reception time of the ultrasonic receiver 112 at which the ultrasonic receiver 112 receives the instruction of distance detection and calculate a relative distance to the slave device 12 according to a flight time of the ultrasonic wave SD (that is, the time difference between the emission time and arrival time of the ultrasonic wave SD). In the present embodiment, since the radio frequency signal RF has a very tiny time delay (about tens of nanoseconds (ns)), the distance error generated from the transmission of radio frequency can be neglected. Let the relative distance between the master device 11 and the slave device 12 be exemplified by 5 m. Since the total signal link delay of signals other than the radio frequency signal RF is controlled to be within 1 ms and the distance error between the master device 11 and the slave device 12 is controlled to be within 30 cm, the transmission delay of the radio frequency signal RF in the air will not affect its accuracy.

Besides, the technology of calculating the relative distance between the master device 11 and the slave device 12 using the flight time of the ultrasonic wave SD advantageously has high accuracy and is not affected by the radio frequency antenna pattern. In contrast, the conventional technology of distance detection using the attenuation of radio frequency power is often affected by the antenna radiation pattern and the accuracy of distance detection is reduced.

Then, refer to FIG. 1, the setting modules 113 and 123 are used for setting a triggering condition for distance detection, and the indication modules 114 and 124 may perform indication according to whether the relative distance between the master device 11 and the slave device 12 is larger than a predetermined distance. In an embodiment, when the master device 11 or the slave device 12 drops from a user or an object of detection (such as a kid or a pet) is away from the user, the master device 11 or the slave device 12 makes determination according to the value of a received signal strength indication (RSSI) and initiates a request for distance detection. After the slave device 12 or the master device 11 correspondingly receives the request for distance detection, the slave device 12 emits an ultrasonic wave SD, and the master device 11, on receiving the ultrasonic wave SD, starts to calculate a flight time of the ultrasonic wave SD to obtain a relative distance to the slave device 12. When the relative distance between the master device 11 and the slave device 12 is smaller than a predetermined distance, the distance detection is performed for at least once. When the relative distance between the master device 11 and the slave device 12 is larger than a predetermined distance, the indication modules 114 and 124 indication the user through at least one of sounding an alarm, making a vibration, flashing an indicator and displaying a subtitle on the screen. After the user receives the warning indication, the risk of the master device 11 or the slave device 12 dropping from the user and becoming lost or the object of detection (such as a kid or a pet) being away from the user can be reduced and the anti-loss effect can be achieved.

The setting module 113 may include a gravity acceleration sensor (G sensor, not illustrated) used for detecting whether the gravity acceleration of the master device 11 or the slave device 12 satisfies a triggering condition. For example, when the master device 11 or the slave device 12 drops from the user and hits the ground, the G sensor of the master device 11 or the slave device 12 detects that the gravity acceleration is larger than a set value, and therefore activates the master device 11 or the slave device 12 to initiate the distance detection.

In another embodiment, the setting module 113 may include a radio frequency power sensor (not illustrated) used for detecting whether the attenuation of the radio frequency power outputted from the master device 11 or the slave device 12 satisfies the triggering condition. For example, the radio frequency power sensor may evaluate an approximate distance between the master device 11 and the slave device 12 and the change of the distance according to the distance detection method using received signal strength indication (RSSI). That is, as the distance between the master device 11 and the slave device 12 increases, the attenuation of the radio frequency power will increase accordingly. Thus, when it is detected that the attenuation of the radio frequency power of the master device 11 or the slave device 12 is larger than a set value, the master device 11 or the slave device 12 will be activated to initiate distance detection and perform distance detection using an ultrasonic wave to obtain more accurate information of distance.

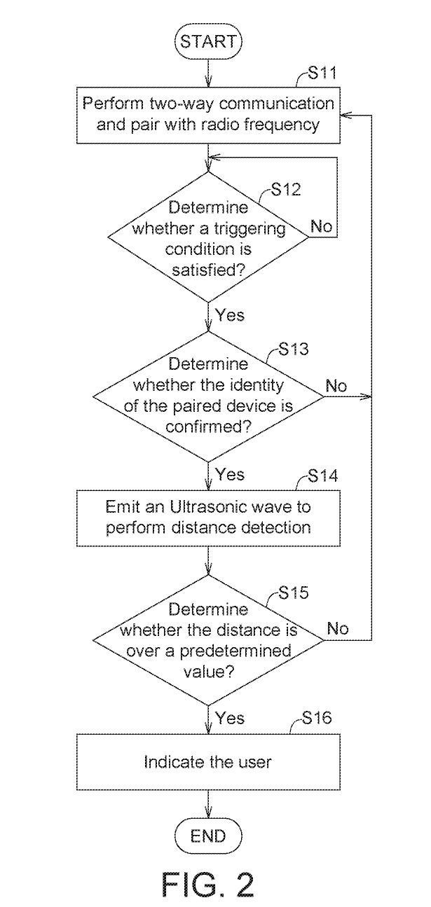

Refer to FIGS. 1 and 2. FIG. 2 is a flowchart of a distance detection method according to an embodiment of the invention. Firstly, at step S11, the master device 11 and the slave device 12 perform two-way communication and pairing with radio frequency. Then, at step S12, whether a triggering condition is satisfied is determined. For example, whether the gravity acceleration of the master device 11 or the slave device 12 or the attenuation of the radio frequency power outputted from the master device 11 or the slave device 12 satisfies a triggering condition is determined. If the triggering condition is satisfied, then the method proceeds to step S13; if the triggering condition is not satisfied, then distance detection is performed for at least once.

Then, at step S13, the master device 11 confirms the identity of the paired slave device 12. For example, before distance detection is performed, the master device 11 outputs a radio frequency inquiry code to the slave device 12, and the slave device 12, having confirmed the radio frequency inquiry code, will inform the master device 11 to complete pairing, Then, the slave device 12 outputs an ultrasonic wave reply code to the master device 11 for the master device 11 to perform distance detection and avoid other slave device 12 making a mistake to reply. Thus, the interference between the slave devices can be reduced and power consumption can be saved. In step S13, if the identity of the paired device is confirmed, then the method proceeds to step S14; if the identity of the paired device cannot be confirmed, then the method returns to step S11 to perform two-way communication and pairing.

Then, at step S14, the slave device 12 emits an ultrasonic wave SD for the master device 11 to perform the distance detection, and the master device 11 can calculate a flight time of the ultrasonic wave SD according to an initiation time of an instruction of distance detection and an arrival time of the ultrasonic wave to obtain a relative distance between the master device 11 and the slave device 12. Then, at step S15, whether the relative distance between the master device 11 and the slave device 12 is larger than a predetermined distance is determined. If the relative distance is not larger than a predetermined distance, then the method returns to step S11 to perform two-way communication and pairing; if the relative distance is larger than the predetermined distance, then the method proceeds to step S16, the user is informed through at least one of sounding an alarm, making a vibration, flashing an indicator and displaying a subtitle on the screen.

The user may also set indication strength or indication type. For example, the indication strength (such as low strength, medium strength, high strength) is set according to whether the relative distance between the master device 11 and the slave device 12 is larger than a predetermined distance (such as 1 m, 2 m, 3 m and so on). Besides, the indication module further may include a display screen for displaying the relative distance between the master device 11 and the slave device 12 detected using the ultrasonic wave, such that the object of detection can be more accurately located.

After the user receives a warning indication, the risk of the master device 11 or the slave device 12 dropping from the user and becoming lost or the object of detection (such as a kid or a pet) being away from the user can be reduced and the anti-loss effect can be achieved. Moreover, in another embodiment, given that the slave device 12 is equipped by the object of detection (such as a kid or a pet) and the master device 11 is equipped by the user, after the user receives an indication, the risk of the slave device 12 being away from the master device 11 over a predetermined distance (such as 5 meters) can be reduced and the object of detection (such as a kid or a pet) will not get lost.

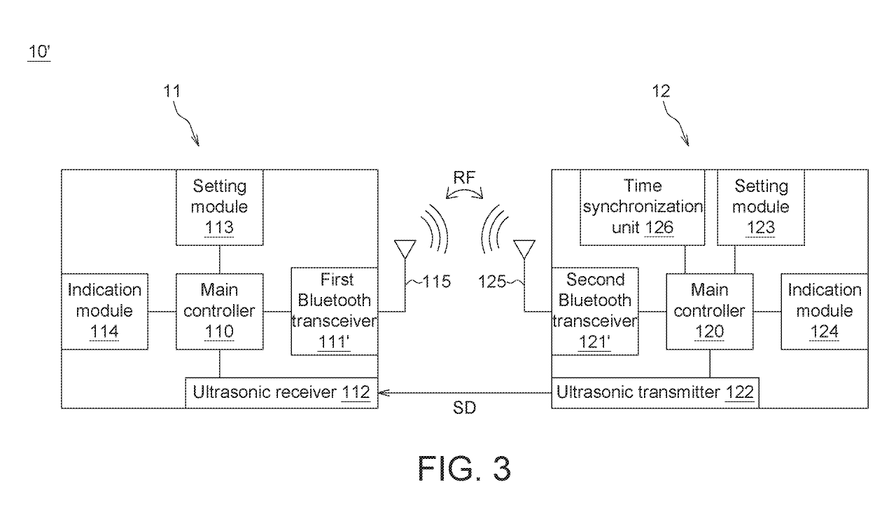

Referring to FIG. 3, a schematic diagram of an electronic device 10′ with a distance detection function according to another embodiment of the invention is shown. The electronic device 10′ with a distance detection function includes a master device 11 and a slave device 12. The present embodiment is different from above embodiments in that two-way communication and pairing are performed by Bluetooth transceivers, and other elements such as the main controllers 110 and 120, the ultrasonic receiver 112, the ultrasonic transmitter 122, the setting modules 113 and 123 and the indication modules 114 and 124 are common to all embodiments and are not repeated here. As indicated in FIG. 3, the first Bluetooth transceiver 111′ and the second Bluetooth transceiver 121′ respectively have an antenna module 115 and an antenna module 125 for transmitting and receiving a radio frequency signal RF of 2.4 GHz to 2.485 GHz. When the master device 11 or the slave device 12 initiates a request for distance detection according to a triggering condition, the first Bluetooth transceiver 111′ outputs a radio frequency inquiry code to the second Bluetooth transceiver 121′, the slave device 12, having confirmed the radio frequency inquiry code, will inform the master device 11 to complete pairing, Then, the ultrasonic transmitter 122 emits an ultrasonic wave reply code to the ultrasonic receiver 112 for the master device 11 to calculate a relative distance.

In the present embodiment, the master device 11 and the slave device 12 can be realized by a mobile phone and a peripheral device or an anti-loss device with Bluetooth function. Once the master device 11 and the slave device 12 are paired, the master device 11 and the slave device 12 will be able to communicate with each other. The master device 11 and the slave device 12 can also perform wireless communication using WIFI or ZigBee technology, and such communication is not restricted in the present invention.

In the present embodiment, although the transmission speed of the radio frequency signal RF is far faster than the transmission speed of the ultrasonic wave SD, the instruction of initiating distance detection cannot be instantly transmitted and replied between the Bluetooth transceivers, and a time delay of 100 milliseconds will occur. Therefore, the present embodiment adopts synchronization so that the delay caused by the Bluetooth transceivers will not affect the accuracy of distance detection.

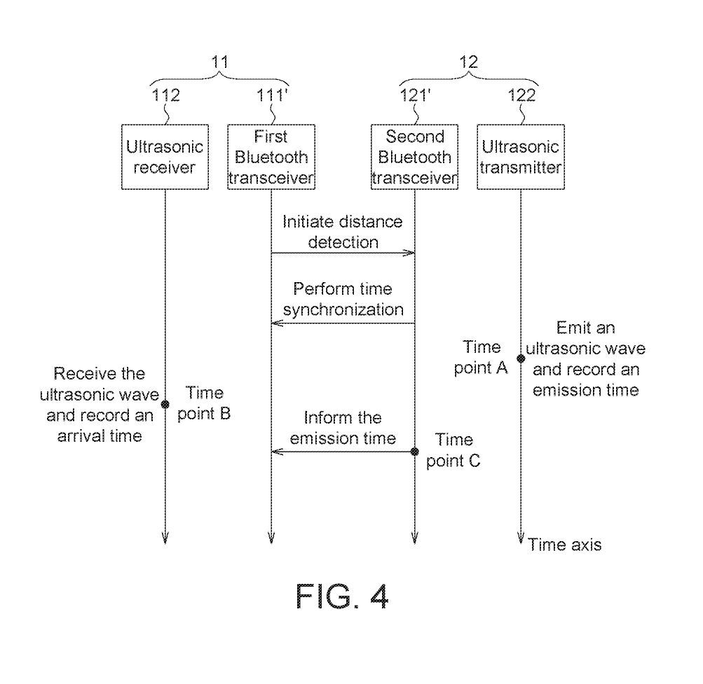

Refer to FIGS. 3 and 4. FIG. 4 is a schematic diagram of a time axis of operation process of the electronic device 10′ with a distance detection function of FIG. 3. The slave device 12 includes a time synchronization unit 126 used for synchronizing the time of the master device 11 and the slave device 12. The time synchronization unit 126 may achieve an accuracy level of 100 microseconds (μs). When the master device 11 or the slave device 12 initiates the distance detection according to a triggering condition, the time synchronization unit 126 can respectively transmit and receive a radio frequency signal RF through a first Bluetooth transceiver 111′ and a second Bluetooth transceiver 121′ to perform synchronization. Then, the slave device 12 records an emission time of an ultrasonic wave SD (represented by time point A). Then, the ultrasonic receiver 112 receives the ultrasonic wave SD from the ultrasonic transmitter 122 and records an arrival time of the ultrasonic wave SD (represented by time point B). Then, after some time delays of the Bluetooth signal, the slave device 12 transmits the previously recorded emission time of the ultrasonic wave SD to the master device 11 through the second Bluetooth transceiver 121′ at time point C.

Thus, the master device 11 may calculate a flight time of the ultrasonic wave SD according to the emission time (time point A) emitted from the slave device 12 and the arrival time of the ultrasonic wave SD (time point B).

In the present embodiment, although the second Bluetooth transceiver 121′ is not able to instantly inform the emission time of the ultrasonic wave SD and therefore result in time delay (represented by time point C), the time synchronization unit 126 completed time synchronization beforehand. Therefore, the master device still can obtain the information of time point A afterwards and calculate the flight time of the ultrasonic wave SD, and the accuracy of distance detection will not be affected by the time delay caused by the Bluetooth transceivers.

According to the electronic device with a distance detection function and the distance detection method using the same disclosed in above embodiments of the invention, a relative distance is calculated according to a flight time of an ultrasonic wave, so that the accuracy of the distance detection can be increased. Since the distance detection is performed using an ultrasonic wave, distance error can be reduced, and the distance detection will not be affected by the antenna radiation pattern.

While the invention has been described by way of example and in terms of the preferred embodiment(s), it is to be understood that the invention 2.0 is not limited thereto. On the contrary, it is intended to cover various modification and similar arrangements and procedures, and the scope of the appended claims therefore should be accorded the broadest interpretation so as to encompass all such modification and similar arrangements and procedures.

What is claimed is:

1. An electronic device with a distance detection function, comprising:
a master device, comprising a first transceiver and an ultrasonic receiver; and
a slave device, comprising a second transceiver and an ultrasonic transmitter performing two-way communication and pairing with a radio frequency, wherein the ultrasonic receiver receives an ultrasonic wave from the ultrasonic transmitter so that the master device calculates a relative distance to the slave device according to a flight time of the ultrasonic wave.

2. The electronic device according to claim 1, wherein
the slave device further comprises a time synchronization unit used for synchronizing the time of the master device and the slave device, wherein the slave device records an emission time of the ultrasonic transmitter and transmits the emission time to the master device through a second Bluetooth transceiver, the ultrasonic receiver receives the ultrasonic wave from the ultrasonic transmitter and records an arrival time of the ultrasonic wave, so that the master device calculates the relative distance between the master device and the slave device according to the emission time and arrival time of the ultrasonic wave.

3. The electronic device according to claim 1, wherein the master device and the slave device further comprise a setting module used for setting a triggering condition for distance detection.

4. The electronic device according to claim 3, wherein the setting module comprises a G sensor used for detecting whether a gravity acceleration of the master device or the slave device satisfies the triggering condition.

5. The electronic device according to claim 3, wherein the setting module comprises a radio frequency power sensor used for detecting whether an attenuation of the radio frequency power outputted from the master device or the slave device satisfies the triggering condition.

6. The electronic device according to claim 3, wherein when the master device or the slave device initiates a distance detection according to the triggering condition, the first transceiver emits a radio frequency inquiry code to the second transceiver, the slave device, having confirmed the radio frequency inquiry code, informs the master device, and the ultrasonic transmitter emits an ultrasonic wave reply code to the ultrasonic receiver for the master device to perform the distance detection.

7. The electronic device according to claim 1, wherein the master device and the slave device further comprise an indication module, which performs indication if a relative distance between the master device and the slave device is larger than a predetermined distance.

8. A distance detection method used in an electronic device, wherein the electronic device comprises a master device and a slave device, and the distance detection method comprises:
performing two-way communication and pairing with a radio frequency by the master device and the slave device;
setting a triggering condition for distance detection;
receiving an ultrasonic wave from the ultrasonic transmitter by the master device when the triggering condition is satisfied; and
calculating a relative distance between the master device and the slave device by the master device according to a flight time of the ultrasonic wave.

9. The distance detection method according to claim 8, wherein when the master device or the slave device initiates distance detection according to the triggering condition, the method further comprises synchronizing the time of the master device and the slave device, wherein the slave device records an emission time of the ultrasonic wave and transmits the emission time to the master device, the master device records an arrival time of the ultrasonic wave and calculates the flight time of the ultrasonic wave according to the emission time of the ultrasonic wave and the arrival time of the ultrasonic wave.

10. The distance detection method according to claim 8, further comprising detecting whether a gravity acceleration of the master device or the slave device satisfies he triggering condition by a G sensor.

11. The distance detection method according to claim 8, further comprising detecting whether an attenuation of a radio frequency power outputted from the master device or the slave device satisfies the triggering condition by a radio frequency power sensor.

12. The distance detection method according to claim 8, wherein the master device or the slave device initiates distance detection according to the triggering condition, the master device emits a radio frequency inquiry code to the slave device, which, having confirmed the radio frequency inquiry code, informs the master device, and the slave device emits an ultrasonic wave reply code to the master device for the master device to perform distance detection.

13. The distance detection method according to claim 8, wherein when a relative distance between the master device and the slave device is larger than a predetermined distance, further comprising providing an indication through at least one of sounding an alarm, making a vibration, flashing an indicator and displaying a subtitle on a screen.
